(19) United States
(12) Patent Application Publication
(10) Pub. No.: US 2009/0205560 A1
(43) Pub. Date: Aug. 20, 2009

(54) THREE DIMENSIONAL DIAL

(75) Inventors: Heinz Behrends, Bad Herrenalb (DE); Jurgen Sannwald, Pfinztal (DE)

Correspondence Address: Johnson Controls, Inc.;c/o Fletcher Yoder PC, P.O. Box 692289, Houston, TX, 77269, US

(73) Assignee: Johnson Control Technology Company, Holland, MI (US)

(21) Appl. No.: 12/372,633

(22) Filed: Feb. 17, 2009

(30) Foreign Application Priority Data
Aug. 18, 2006 (DE) 10 2006 038 784.8
Aug. 15, 2007 (EP) PCT/EP2007/007197

(51) Int. Cl. G01D 13/02

(52) U.S. Cl. 116/334

(57) ABSTRACT

A motor vehicle display device includes a dial with a backing layer. The backing layer is three-dimensionally formed. The backing layer may be a film and may have a layer of reflective material, such as chromium, and a color layer. The display device may be translucent and may include display means, such as a color layer and gaps for permitting passage of back light.

### CROSS REFERENCE TO RELATED APPLICATIONS

This application claims priority from and the benefit of PCT Application No PCT/EP2007/007197, filed on Aug. 15, 2007; and German Patent No. DE 10 2006 038 784.8, filed on Aug. 18, 2006, both entitled “Three Dimensional Dial”, which are hereby incorporated by reference.

### BACKGROUND

The present invention relates to a motor vehicle display device comprising a dial, which has a backing layer.

Such display devices of the generic type are disclosed, for example, by the German utility models DE 85 01 393 and G 93 01 584. The display devices taught there, however, are often not easily legible under all light conditions and are comparatively expensive to manufacture.

The object of the present invention therefore was to provide a motor vehicle display device, which does not have the disadvantages inherent in the state of the art.

The object is achieved by a motor vehicle display device comprising a dial, which has a backing layer, wherein the backing layer is three-dimensionally formed and is preferably deep-drawn.

### SUMMARY

It was extremely surprising to the person skilled in the art that the device according to the invention unexpectedly proved very easy to produce and is easily legible both in daylight and at night. The display device according to the invention has a comparatively low weight.

For the purposes of the present invention a display device is any instrument display which imparts information on the instantaneous state of the vehicle to the occupant of the vehicle. Speedometers, rev counters, oil pressure indicators, fuel gauges and temperature gauges are just some examples.

According to the invention this display device has a backing layer, which affords the display device its necessary stability, for example. According to the invention this backing layer is plastically formed in three dimensions and is preferably deep-drawn.

This forming of the backing layer means that it can be made thinner whilst affording the same or improved mechanical stability, which represents a saving both in weight and material. The display device according to the invention furthermore has curved areas in the dial, which are thereby optically emphasized or especially easy to read, because they are non-reflective, for example.

The backing layer may be manufactured from any material familiar to the person skilled in the art. This is preferably a plastic, however, and more preferably still an at least partially transparent plastic. The backing layer is made of a material such as polycarbonate, for example.

In an especially preferred embodiment of the present invention the backing layer is a film, preferably having a thickness of 0.3 to 0.5 millimeters. This preferred embodiment of the present invention has the advantage that the backing layer is especially easy to deform. In deforming by deep-drawing the film, at least in the areas that are to be deformed, is heated and then plastically deformed. It is also feasible, however, to cold-draw the film as a whole.

According to a further subject of the present invention or a preferred embodiment of the aforesaid invention the backing layer has a chromium layer. The inventive or preferred embodiment has the advantage that light from a light source, which is located on the side of the inventive display device remote from the vehicle occupant, only shines partially through the dial. The light is thereby dimmed and cannot, for example, dazzle the vehicle occupant, although the dial is illuminated.

The chromium layer is preferably applied to the backing layer, and in particular the film, by vapor deposition or sputtering.

Further details apply equally to both subjects of the invention.

The backing layer preferably has a color layer. The color of this color layer is entirely a matter of choice. The color layer is preferably translucent, either in itself or in combination with the chromium layer, so that the light from a light source, which is located behind the backing layer, shines at least partially through the backing layer.

In a further preferred embodiment of the present invention the display device according to the invention comprises display means, such as numerals, letters, scale marks, symbols or the like, for example. The color layer is more preferably still not arranged in the area of the display means, so that the display means are particularly easy to read. These display means may be applied to the inventive backing layer, for example, by masking the backing layer with a template before application of the color layer, so that the color layer is not applied in the area of the display means.

A further color is most preferably arranged in the area of the display means, so that these are especially visible. This effect is produced by first applying a color layer, which corresponds to the color of the display means, to the backing layer. This color layer of the display means is then covered over by the color of the color layer of the backing layer, the display means again being masked.

The person skilled in the art will appreciate that some display means may have a special color whilst others do not. The latter are then chromed.

A luminous means is preferably arranged behind the backing layer, preferably on the rear side, that is to say the side remote from the vehicle occupant. The luminous means is most preferably a lamellar luminous means. In a still more preferable embodiment the luminous means comprises a light guide, in particular a lamellar light guide. This embodiment of the present invention has the advantage that the light source, such as LEDs, for example, can be arranged at a greater distance from the backing layer. For the purpose of this invention lamellar light guides are, for example, light guide plates in which light is distributed uniformly over a circular cross section and which are substantially plate-shaped.

The luminous means may also be a backlit display, that is to say a display which is situated behind the backing layer.

### DRAWINGS

The inventions will be explained below with reference to FIGS. 1 to 3. These explanations are given merely by way of example and do not limit the general idea of the invention.

FIG. 1 shows the backing layer of the display device according to the invention.

FIGS. 2A and 2B show possible layer structures of the backing layer according to FIG. 1.

FIG. 3 shows the display device incorporated into the instrument panel.

### DETAILED DESCRIPTION

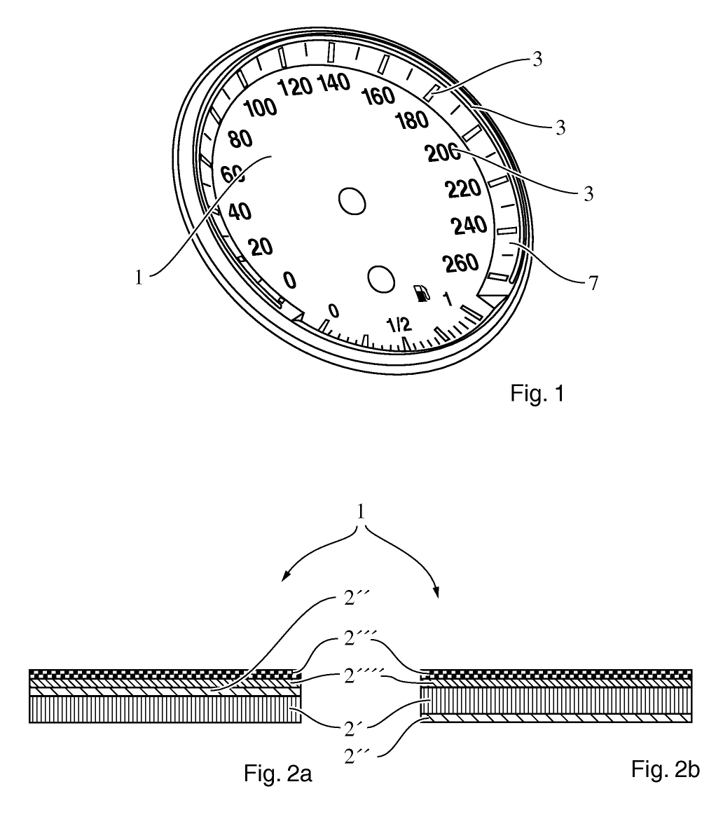

FIG. 1 shows the display device 1 according to the invention, in this case a motor vehicle speedometer dial which is made from a three-dimensionally formed chromium film 2′. A chromium film is a film onto which a chromium layer is applied. The dial 1 furthermore comprises a fuel gauge display and a cruise control display. This chromium film has a turned-up edge at the circumference, which has an inclined horseshoe-shaped display scale 7. A circumferential ring 3, which serves as cruise control display, is arranged at the upper edge of the incline. The cruise control display can serve to indicate the speed to which the cruise control is set. The scale marks, the cruise control display or the numerals 3 and the fuel gauge display are produced by applying, for example by spraying, a translucent color 2′″, in this case black, onto the dial on the side facing the occupant, the speedometer display and the scale marks, the fuel gauge display and the cruise control display being masked and therefore remaining chromed when the color is applied. It is also feasible, however, for the numerals to be white. This embodiment of the device according to the invention is produced by first applying another translucent color 2″″, the color of the numerals and/or the scale marks, to the chromium film before the translucent black color 2′″. This other color is then sprayed over with the translucent color 2′″ whilst masking the numerals and/or the scale marks. The person skilled in the art will appreciate that it is also possible to provide just some display means with a special color 2″″ and to leave the others chromed.

A light source, which is arranged behind the dial 1, allows the latter to shine uniformly in a warm color shade, the display means 3 standing out more sharply when illuminated by the light source.

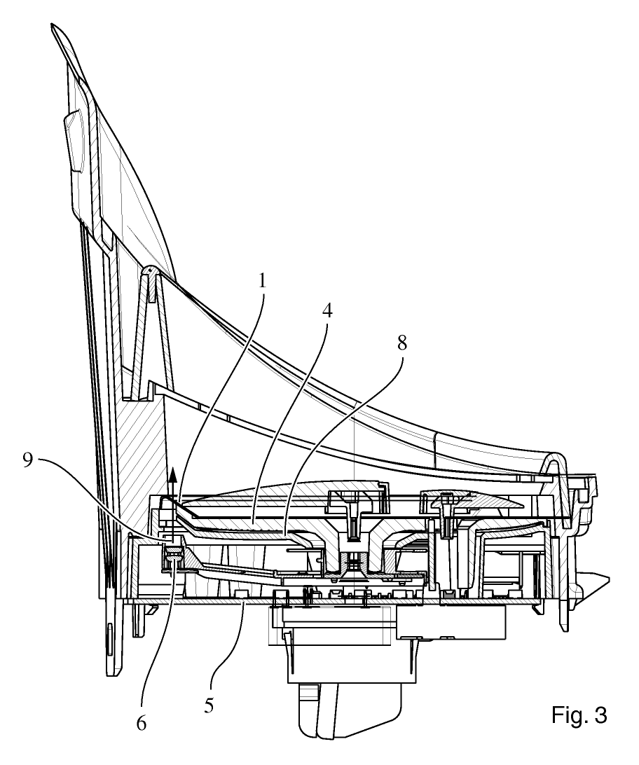

FIGS. 2A and 2B show possible layer structures of the display device according to the invention. FIG. 2A shows the backing layer 2′, on which the chromium layer has been applied by vapor deposition. This chromium layer 2″ is masked by the color layer 2″″ of the display means 3, for example the numerals or the scale marks, and is finally sprayed over with the color layer 2′″, the numerals or the scale marks being masked. The entire layer is translucent both in the area of the numerals and in the remaining area, so that a light source, which is arranged on the side remote from the passenger, shines at least partially though the display device. This thereby appears to be faintly illuminated uniformly over the entire surface, the display means shining more brightly.

The display device according to FIG. 2B corresponds substantially to the display device according to FIG. 2A, the chromium layer 2″ in this case, however, being arranged on the other surface of the backing layer 2′. Otherwise reference should be made to the details relating to FIG. 2A.

FIG. 3 shows the display device 1 according to the invention, which in this case is fitted into an instrument panel. The display device has an LED housing with an LED circuit board, which serves to generate the light. The LED may emit white and/or colored light. This light is directed by means of optical deflecting elements, such as reflective surfaces or lenses, to a lamellar light guide 4, a light guide plate, beneath the dial 1. The optical elements are preferably part of the light guide. The LED housing reflects light that does not shine in the direction of the dial back into the lamellar light guide. The lamellar light guide 4 illuminates the entire dial 1, a proportion of the light shining through the backing layer and the other layers, so that in the case of a black covering layer 2!″ this appears colored. The light guide 4 furthermore illuminates the numerals and/or the scale marks 3, which since they are not masked by the color layer 2′″ shine more brightly that the remainder of the dial. The backlit display 6 has its own light source, such as LEDs, for example, and possibly optical means. The light source emits light, as represented by the arrow 9, into the upper area of the cruise control display 3, so that an illuminated area is produced there, which indicates to the vehicle occupant at what speed the cruise control is set. This illuminated area may take the form of a spot, a circle, a triangle, a rectangle or the like.

1. A motor vehicle display device, comprising a dial, which has a backing layer, wherein the backing layer is three-dimensionally formed.

2. The display device as claimed in claim 1, wherein the backing layer is a film.

3. The display device as claimed in claim 1, wherein the backing layer is provided with a chromium layer.

4. The display device as claimed in claim 1, wherein the backing layer is provided with a color layer.

5. The display device as claimed in claim 1, wherein the display device is translucent.

6. The display device as claimed in claim 1, wherein the display device has display means.

7. The display device as claimed in claim 6, wherein the display means comprise gaps in a color layer.

8. The display device as claimed in claim 7, comprising a further color.

9. The display device as claimed in claim 7, wherein a luminous means is arranged on a rear side of the display means.

10. The display device as claimed in claim 9, wherein the luminous means is at least one lamellar luminous means.

11. The display device as claimed in claim 10, wherein the luminous means comprises a light guide.

12. The display device as claimed in claim 11, wherein the light guide is a lamellar light guide.

13. The display device as calimed in claim 1, wherein the backing layer is deep-drawn.
